(19) United States
(12) Patent Application Publication
(10) Pub. No.: US 2022/0340776 A1
(43) Pub. Date: Oct. 27, 2022

(54) A Silane-Functional Hardener for Carboxyl-Functional Resins, A Binder and a 2K Coating Composition Thereof

(71) Applicant: BASF Coatings GmbH, Münster (DE)

(72) Inventors: Christian Gerhard SCHAEFER, Shanghai (CN); Yang ZHANG, Shanghai (CN); Stefan HIRSEMANN, Shanghai (CN); Ranjit SALVI, Shanghai (CN); Claas Henrik HOEVELMANN, Muenster (DE); Jana Maria WREDE, Paderborn (DE)

(21) Appl. No.: 17/754,448

(22) PCT Filed: Sep. 28, 2020
(86) PCT No.: PCT/EP2020/077143

§ 371 Date: Apr. 1, 2022

(30) Foreign Application Priority Data
Oct. 9, 2019 (CN) PCT/CN2019/110161

(51) Int. Cl. C09D 183/06; C09D 133/12; C09D 163/10; C09D 175/02

(52) U.S. Cl. CPC C09D 183/06; C09D 133/12; C09D 163/10; C09D 175/02

(57) ABSTRACT

Disclosed herein is a silane-functional hardener for carboxyl-functional resins including at least one monomer and/or oligomer and/or polymer having at least one group represented by Formula I-(a) and/or Formula I-(b) and at least one group represented by Formula II-(a) and/or Formula II-(b):

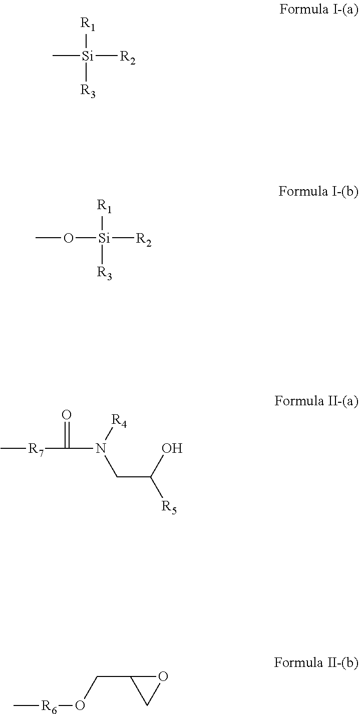

where, R₁, R₂ and R₃ independently represent a C1-C18 alkyl group, C1-C6 alkoxyl group, phenyl group, aryl group, hydrogen atom, chlorine atom or fluorine atom and at least one of R₁, R₂ and R₃ is a C1-C6 alkoxyl group, R₄ represents a C1-C18 alkyl group, C1-C6 alkanol group, C1-C6 alkoxyl group, or hydrogen atom, R₅ represents a hydrogen atom, C1-C18 alkyl group, or C1-C6 alkoxyl group, R₆ represents a C2-C6 acyl group, C1-C18 alkylene group or arylene group and R₇ represents a —NR₄— group, C2-C6 acyl group, C1-C18 alkylene group, C1-C18 alkoxy group or arylene group.

### TECHNICAL FIELD

This invention relates to a silane-functional hardener for carboxyl-functional resins, a binder obtained from a reaction of such silane-functional hardener and carboxyl-functional resins, 2K coating composition comprising such silane-functional hardener in one barrel and at least one carboxyl-functional resin in the other barrel as well as coating layers obtained from the 2K coating composition used as automotive coats such as electrodeposition coat, primer, basecoat and clearcoat.

### BACKGROUND

Lots of automotive coats are based on thermoset coatings that are cured by reaction of resins and hardeners having functionality that reacts with the functionality of the resin such as a combination of carboxyl-functional polyacrylate and epoxy-functional hardener, or a combination of hydroxyl-functional alkyd resin and melamine-functional hardener. Normally those coats have low chemical resistance and scratch resistance. To improve such properties, silanes are introduced into coating compositions. Silanes are easily hydrolyzed to form silsesquioxane networks that provides excellent properties like good chemical resistance, scratch resistance and weatherability etc.

The U.S. Pat. No. 6,045,870 disclosed an organic solvent-based heat-curable high solid coating composition comprising a carboxyl-containing compound of which 20% or more of the carboxyl groups are silylated, at least one epoxide selected from an epoxy-, hydroxyl- and hydrolysable alkoxysilyl-containing vinyl polymer or the vinyl polymer of which 20% or more of the hydroxyl groups are silylated and a crosslinked particulate polymer. However, it only focused on solvent-borne coating system and did not mention water-borne coating system.

Therefore, it is still required to find out a new approach to introduce silane functionality into traditional coating compositions that is applicable for both solvent-borne and water-borne coating systems to obtain coating layers having good chemical resistance and scratch resistance etc.

### SUMMARY OF THE INVENTION

In one aspect, the present invention provides a silane-functional hardener for carboxyl-functional resins comprising at least one monomer and/or oligomer and/or polymer having at least one group represented by Formula I-(a) and/or Formula I-(b) and at least one group represented by Formula II-(a) and/or Formula II-(b):

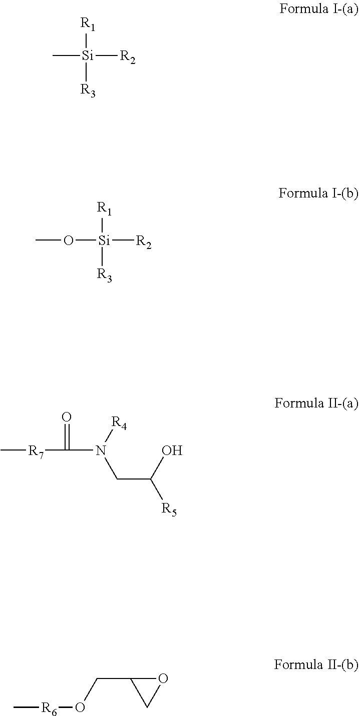

wherein, R₁, R₂ and R₃ are independently representing a C1-C18 alkyl group, C1-C6 alkoxyl group, a phenyl group, an aryl group, a hydrogen atom, a chlorine atom or a fluorine atom and at least one of R₁, R₂ and R₃ is C1-C6 alkoxyl group, R₄ is representing a C1-C18 alkyl group, C1-C6 alkanol group, C1-C6 alkoxyl group, or a hydrogen atom, R₅ is representing a hydrogen atom, C1-C18 alkyl group, or C1-C6 alkoxyl group, R₆ is representing a C2-C6 acyl group, C1-C18 alkylene group or arylene group and R₇ is representing a —NR₄— group, C2-C6 acyl group, C1-C18 alkylene group, C1-C18 alkoxy group or arylene group.

In another aspect, the present invention provides a binder obtained from a reaction of the invented silane-functional hardener and at least one carboxyl-functional resin.

In another aspect, the present invention provides a 2K coating composition comprising the invented silane-functional hardener in one barrel and at least one carboxyl-functional resin in the other barrel.

In a further aspect, the present invention provides a coating layer obtained from the reaction of components in one barrel and components in the other barrel of the invented 2K coating composition.

It is surprisingly found that silane-functional hardener for carboxyl-functional resins of the present invention will lead to a coating layer having a better scratch, alkali as well as acid etch resistance.

### DETAILED DESCRIPTION OF THE INVENTION

The following terms, used in the present description and the appended claims, have definitions as below:

Expressions “a”, “an”, “the”, when used to define a term, include both the plural and singular forms of the term.

All percentages are mentioned by weight unless otherwise indicated.

The term “and/or” includes the meanings “and”, “or” and also all the other possible combinations of the elements connected to this term.

The term “polymer”, as used herein, refers to homopolymers i.e. polymers prepared from a single reactive compound.

The term “copolymer”, as used herein, refers to polymers prepared by reaction of at least two polymer forming reactive, monomeric compounds.

The term “oligomer”, as used herein, refers to homopolymers that have two to three repetitive units of a single monomeric compounds.

The term “co-oligomer”, as used herein, refers to copolymers that have two to three repetitive units in total of two or three monomeric compounds.

The term “binder”, as used herein, refers to the film forming components of the coating compositions. Thus, resins and hardeners are part of the binder, but solvents, pigments, additives like antioxidants, HALS, UV absorbers, leveling agents, and the like are not part of the binder.

The term “hardener”, as used herein, refers to a crosslinking agent or curing agent reactive to resins of coating compositions.

The term “2K”, or “two-component”, as used herein, refers to a composition comprising two components, each of which may also be a mixture of several compounds. The two components can be blended together if needed. And the two components may also be two independent barrels that can be mixed on the spot for applications.

The term “solid content”, as used herein, refers to a weight percentage of non-volatile materials contained in a suspension such as coating, paint etc.

### Silane-Functional Hardener

The silane-functional hardener of the present invention is a monomeric or oligomeric or polymeric compound containing silane functionalities as illustrated in Formula I-(a) and/or Formula I-(b), and at least one selected from beta-hydroxylalkyl amine functionalized carbonyl compound (amide, urethane, urea) as illustrated in Formula II-(a) and epoxy functionalities as illustrated in Formula II-(b):

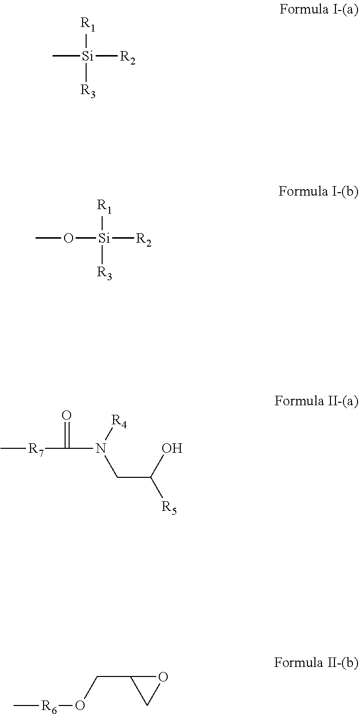

wherein, R₁, R₂ and R₃ are independently representing a C1-C18 alkyl group, C1-C6 alkoxyl group, a phenyl group, an aryl group, a hydrogen atom, a chlorine atom or a fluorine atom and at least one of R₁, R₂ and R₃ is C1-C6 alkoxyl group, R₄ is representing a C1-C18 alkyl group, C1-C6 alkanol group, C1-C6 alkoxyl group, or a hydrogen atom, R₅ is representing a hydrogen atom, C1-C18 alkyl group, or C1-C6 alkoxyl group, R₆ is representing a C2-C6 acyl group, C1-C18 alkylene group or arylene group and R₇ is representing a —NR₄— group, 02-C6 acyl group, C1-C18 alkylene group, C1-C18 alkoxy group or arylene group.

Preferably, R₁, R₂ and R₃ in Formula I-(a) and Formula I-(b) are preferably representing C1-C6 alkoxyl group and more preferably representing methoxy and/or ethoxy. Preferably, R₄ in Formula II-(a) is preferably representing C1-C6 alkanol group and R₅ in Formula II-(a) is preferably representing hydrogen atom. Preferably, R₆ in Formula II-(b) is preferably representing carbonyl or C2-C6 acyl group.

In a particular example, the silane functional hardener for carboxyl-functional resins comprising at least one monomer and/or oligomer and/or polymer having at least one group represented by Formula I-(a) and/or Formula I-(b) and at least one group represented by Formula II-(a) and/or Formula II-(b):

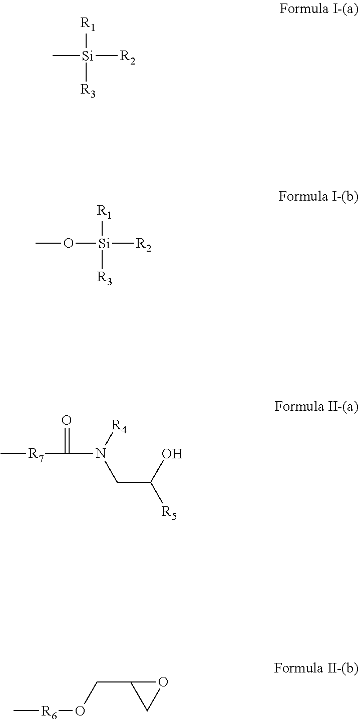

wherein R₁, R₂ and R₃ are methoxy or ethoxy groups, R₄ is ethyl hydroxyl group, R₅ is a hydrogen atom, R₆ is a carbonyl group and R₇ is a —NH— group.

The backbone of oligomer in the silane-functional hardener preferably comprises at least one selected from (meth)acrylate oligomer and/or its co-oligomer, isocyanate oligomer and/or its co-oligomer.

The backbone of polymer in the silane-functional hardener preferably comprises at least one selected from poly(meth)acrylate and/or its copolymer, polyamide and/or its copolymer, polyurethane and/or its copolymer, polyester and/or its copolymer, polyether and/or its copolymer, polyolefin and/or its copolymer, polyurea and/or its copolymer and polyisocyanate and/or its copolymer. Such copolymer preferably comprises at least one alkoxysilane and epoxy and/or amine functionalized carbonyl compound (amide, urethane, urea) as end groups or side groups.

The silane-functionalities of the silane-functional hardener of the present invention enables silane self-crosslinking while the epoxy and/or beta-hydroxylalkyl amine functionalized carbonyl compound (amide, urethane, urea) enables the crosslinking with carboxyl groups of carboxyl-functional resins. Such kind of “dual-curing” leads to interacted polymer and silsesquioxane networks and as a result crack of coating layer is effectively suppressed without adding any further film-forming polymer or other additives such as plasticizer.

The molar ratio of silane functionalities and epoxy and/or beta-hydroxyl-alkyl functionalities could significantly influence the curing effects after reacting with carboxyl-functional resins. A higher percentage of silsesquioxane networks tends to bring a higher hardness and better scratch resistance while a higher percentage of polymer networks formed by epoxy-carboxyl reaction or beta-hydroxylalkyl amine functionalized carbonyl compound (amide, urethane, urea)-carboxyl reaction or both tends to bring a better tension strength. Therefore, a proper range of such molar ratio is needed to achieve balanced properties of the coating layer. Preferably, the molar ratio of silane functionalities and epoxy and/or beta-hydroxylalkyl amine functionalized carbonyl compound (amide, urethane, urea) is from 0.1 to 10.0 and more preferably from 0.5 to 2.0.

The silane-functional hardener could be used in both solvent-borne and water-borne system.

In one embodiment, the silane-functional hardener is epoxy-functional alkoxysilane polymer obtained from reactions between vinyl trimethoxysilane, methyl methacrylate, n-butyl acrylate, styrene, glycidyl methacrylate and n-dodecane thiol with existing of the initiator of ditertbutyl peroxide.

In another embodiment, the silane-functional hardener is monomeric silane functional beta-hydroxyl-alkyl urea obtained from reactions between diethanolamine and 3-isocyanatopropyl-triethoxysilane.

In another embodiment, the silane-functional hardener is oligomeric silane functional beta-hydroxyl-alkyl urea obtained from reactions between bis(3-triethoxysilylpropyl)amine and aliphatic polyisocyanate resin based on hexamethylene diisocyanate and diethanolamine.

In a further embodiment, a water-borne silane-functional hardener is obtained from reactions of bis(3-triethoxylsilylpropyl)amine, aliphatic polyisocyanate resin based on hexamethylene diisocyanate, polyethylene glycol and diethanolamine.

### Carboxyl-Functional Resin

The carboxyl-functional resin of the present invention is any type of carboxyl groups containing polymer and/or copolymer that is used in coatings as a binder resin.

Preferably, the carboxyl-functional resin is at least one selected from the group consisting of carboxyl-functional polyacrylics, carboxyl-functional polyesters, carboxyl-functional polyurethanes, and carboxyl-functional polyamides and/or their copolymers.

Preferably, said carboxyl-functional resins comprises at least one carboxyl-functional poly(meth)acrylate. The carboxyl-functional polyacrylics suitable for the present invention can also be obtained from the polymerization of a monomer mixture containing a hydroxy alkyl(meth)acrylate monomer and a linear or cyclic alkyl dicarboxylacid or the anhydride thereof, such as linear or cyclic C2-C6 alkyl dicarboxylacid or the anhydride thereof. In addition, in an embodiment of the present invention, the monomer mixture may further contain a lactone monomer.

Nonlimiting examples of the hydroxy alkyl(meth)acrylate monomers that can be used in the present invention comprise hydroxyl C2-C4alkyl (meth)acrylate, such as hydroxyethyl (meth)acrylate, hydroxybutyl (meth)acrylate and hydroxypropyl (meth)acrylate.

Nonlimiting examples of the lactone monomer that can be used in the present invention comprise γ-butyrolactone, δ-valerolactone and ε-caprolactone.

Nonlimiting examples of the linear or cyclic alkyl dicarboxyl acid or the anhydride thereof that can be used in the present invention include succinic acid, glutaric acid, adipic acid, 25 cyclobutane-1,2-dicarboxylacid, cyclopentane-1,2-dicarboxylacid, 1,2-cyclohexanedicarboxylacid, and the anhydride thereof.

Other monomers may also be used as comonomer in preparing the carboxyl-functional polyacrylics suitable for the present invention. Such comonomer may be, such as, styrene, (meth)acrylates, and the like. For example, the (meth)acrylate may be selected from the group consisting of methyl acrylate, methyl methacrylate, ethyl acrylate, ethyl methacrylate, propyl acrylate, propyl methacrylate, isopropyl acrylate, isopropylmethacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, 2-ethylhexyl acrylate, 2-ethylhexyl methacrylate, 3,3,5-trimethylhexyl acrylate, and 3,3,5-trimethylhexyl methacrylate.

The carboxyl-functional polyacrylics suitable for the present invention may be prepared using conventional free radical polymerization techniques, such as by heating the monomers in the presence of a polymerization initiator.

The carboxyl-functional resins of the present invention may also be carboxyl-functional polyesters, carboxyl-functional polyurethanes, carboxyl-functional polyether and carboxyl-functional polyamides that are suitable for being used as binder resin in coating compositions.

The carboxyl-functional resin of the present invention is solvent-borne or water-borne. Preferably, the acid number of the carboxyl-functional resin is in the range from 70 to 300 mg KOH/g and more preferably from 100 to 200 mg KOH/g.

In one embodiment, a solvent-borne carboxylic acid functional polyester is obtained by reactions of hexahydrophthalic anhydride, dodecanoic acid, pentaerythritol with existing of a solvent of solvent naphtha, the resultant resin has a weight-average molecular weight of 3000 g/mol and an acid value of 181 mg KOH/g.

In another embodiment, a solvent-borne carboxylic acid functional polyacrylate is obtained by reactions of acrylic acid, n-butyl acrylate, styrene, ethylhexyl acrylate and dodecyl mercaptan with existing of initiator solution of di-tertiary butylperoxide in solvent naphtha and a solvent mixture of 1-butanol and solvent naphtha, the resultant resin has a weight-average molecular weight of 3000 g/mol and an acid value of 131 mg KOH/g.

In another embodiment, a water-borne carboxylic acid functional polyacrylate is obtained by reactions of styrene, 2-ethyl hexylmethacrylate, methacrylic acid, methyl methacrylate, n-butyl methacylate and dimethylaminoethanol with existing of initiator solution of tertiary butylperoxyl-2-ethylhexanoate in butyl glycol and a solvent mixture of butyl glycoland water, the resultant resin has a weight-average molecular weight of 3800 g/mol, an acid value of 178 mg KOH/g and a neutralization degree of 75%.

In a further embodiment, a water-borne carboxylic acid functional polyester is obtained by reactions of adipic acid, trimethylolpropane, hexahydrophthalic anhydride, Cardura E10 with and dimethylaminoethanol with existing of a solvent mixture of ethyl 3-ethoxypropionate and water, the resultant resin has a weight-average molecular weight of 3800 g/mol, an acid value of 180 mg KOH/g and a neutralization degree of 70%.

### Binder

A binder is obtained from a reaction of the silane-functional hardener of the present invention and at least one carboxyl-functional resin. Both solvent-borne and water-borne binder could be prepared by selecting solvent-borne or water-borne silane-functional hardener and carboxyl-functional resins. Organic solvent such as butyl acetate or 1-butanol could be added to prepare solvent-borne binder. Other additives and/or co-hardener such as silicone-based surfactant or reactive organofunctional siloxanes could be added as well.

Preferably, carboxyl-functional resin used for forming a binder comprise at least one selected from carboxyl-functional polyester, carboxyl-functional poly(meth)acrylate, carboxyl-functional polyurethane, carboxyl-functional polyurea, carboxyl-functional polyether, carboxyl-functional polyamide and/or their copolymers.

Preferably, the surface hardness of the binder is no less than 75 times according to the test standard ISO 1522.

Preferably, the solvent rub value of the binder is no less than 200 times according to MEK (methylethylketone) double rub test.

In one embodiment, a solvent-borne binder is obtained from the reaction of solvent-borne carboxylic acid functional polyester and monomeric silane functional beta-hydroxyl-alkyl urea or oligomeric silane functional beta-hydroxy-alkyl urea or epoxy-functional alkoxysilane polymer with existing of a solvent of butyl acetate or 1-butanol.

In another embodiment, a solvent-borne binder is obtained from the reaction of solvent-borne carboxylic acid functional polyacrylate and monomeric silane functional beta-hydroxyl-alkyl urea or oligomeric silane functional beta-hydroxy-alkyl urea or epoxy-functional alkoxysilane polymer with existing of a solvent of butyl acetate or 1-butanol.

In another embodiment, a water-borne binder is obtained from the reaction of water-borne carboxylic acid functional polyacrylate and monomeric silane functional beta-hydroxyl-alkyl urea or water-borne oligomeric silane functional beta-hydroxyl-alkyl urea.

In a further embodiment, a water-borne binder is obtained from the reaction of water-borne carboxylic acid functional polyester and monomeric silane functional beta-hydroxyl-alkyl urea or water-borne oligomeric silane functional beta-hydroxyl-alkyl urea.

The solid content of the solvent borne binder is no less than 35% while that of the water borne binder is no less than 50%.

### 2K Coating Composition

A 2K coating composition comprises Component A and Component B, Component A comprises at least one carboxyl-functional resin and Component B comprises at least one silane-functional hardener in the other barrel.

Preferably, the carboxyl-functional resin comprises at least one selected from carboxyl-functional polyester, carboxyl-functional poly(meth)acrylate, carboxyl-functional polyurethane, carboxyl-functional polyurea, carboxyl-functional polyether, carboxyl-functional polyamide and/or their copolymers.

In one embodiment, Component A of the 2K coating composition comprises carboxyl-functional resin, organic solvent and catalysts and Component B of the 2K coating composition comprises silane-functional hardener and organic solvent. Other additives could be added into Component A or Component B according to actual requirements.

The Component A and Component B of the 2K coating composition are mixed to get a dried and cured coating layer. Preferably, the obtained coating layer could be used as automotive coats including electrodeposition coat, primer, basecoat and clearcoat.

The surface harness of the coating layer is no less than 110 times according to the test standard ISO 1522. The scratch resistance of the coating layer is no less than 70% according to 20° gloss retention test. The acid etch resistance is not less than 80% according to 20° gloss retention test. And the alkali etch resistance is not less than 90% according to 20° gloss retention test.

### EMBODIMENTS

The following embodiments are used to illustrate the invention in more details. The 1^{st} embodiment is a silane-functional hardener for carboxyl-functional resins comprising at least one monomer and/or oligomer and/or polymer having at least one group represented by Formula I-(a) and/or Formula I-(b) and at least one group represented by Formula II-(a) and/or Formula II-(b):

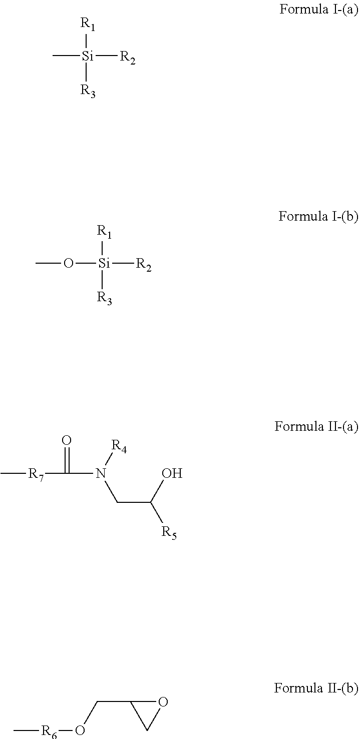

wherein, R₁, R₂ and R₃ are independently representing a C1-C18 alkyl group, C1-C6 alkoxyl group, a phenyl group, an aryl group, a hydrogen atom, a chlorine atom or a fluorine atom and at least one of R₁, R₂ and R₃ is C1-C6 alkoxyl group, R₄ is representing a C1-C18 alkyl group, C1-C6 alkanol group, C1-C6 alkoxyl group, or a hydrogen atom, R₅ is representing a hydrogen atom, C1-C18 alkyl group, or C1-C6 alkoxyl group, R₆ is representing a C2-C6 acyl group, C1-C18 alkylene group or arylene group and R₇ is representing a —NR₄— group, C2-C6 acyl group, C1-C18 alkylene group, C1-C18 alkoxy group or arylene group.

The 2^{nd} embodiment is the silane-functional hardener for carboxyl-functional resins according to the 1^{st} embodiment, wherein R₁, R₂ and R₃ in Formula I-(a) and Formula I-(b) are preferably representing C1-C6 alkoxyl group and more preferably representing methoxy and/or ethoxy.

The 3^{rd} embodiment is the silane-functional hardener for carboxyl-functional resins according to any one of embodiments 1 to 2, wherein R₄ in Formula II-(a) is preferably representing C1-C6 alkanol group and R₅ in Formula II-(a) is preferably representing hydrogen atom.

The 4^{th} embodiment is the silane-functional hardener for carboxyl-functional resins according to any one of embodiments 1 to 3, wherein R₆ in Formula II-(b) is preferably representing carbonyl or C2-C6 acyl group.

The 5^{th} embodiment is the silane-functional hardener for carboxyl-functional resins according to any one of embodiments 1 to 4, wherein the molar ratio of groups represented by Formula I-(a) and Formula I-(b) and groups represented by Formula II-(a) and Formula II-(b) is from 0.1 to 10 and preferably from 0.5 to 2.0.

The 6^{th} embodiment is the silane-functional hardener for carboxyl-functional resins according to any one of embodiments 1 to 5, wherein the backbone of said oligomer preferably comprises at least one selected from (meth)acrylate oligomer and/or its co-oligomer, isocyanate oligomer and/or its co-oligomer.

The 7^{th} embodiment is the silane-functional hardener for carboxyl-functional resins according to any one of embodiments 1 to 5, wherein the backbone of said polymer preferably comprises at least one selected from poly(meth)acrylate and/or its copolymer, polyurea and/or its copolymer.

The 8^{th} embodiment is the silane-functional hardener for carboxyl-functional resins according to the 7^{th} embodiment, wherein said copolymer preferably comprises at least one alkoxysilane and epoxy and/or amine functionalized carbonyl compound as end groups or side groups.

The 9^{th} embodiment is the silane-functional hardener for carboxyl-functional resins according to the 8^{th} embodiment, wherein said amine functionalized carbonyl compound is at least one selected from amide, urethane and urea.

The 10^{th} embodiment is the silane-functional hardener for carboxyl-functional resins according to any one of embodiments 1 to 9, wherein said hardener is solvent-borne or water borne.

The 11^{th} embodiment is a binder obtained from a reaction of the silane-functional hardener according to any one of embodiments 1 to 10 and at least one carboxyl-functional resin.

The 12^{th} embodiment is the binder according to the 11^{th} embodiment, wherein said carboxyl-functional resin comprise at least one selected from carboxyl-functional polyester, carboxyl-functional poly(meth)acrylate, carboxyl-functional polyurethane, carboxyl-functional polyurea, carboxyl-functional polyether, carboxyl-functional polyamide and/or their copolymers.

The 13^{th} embodiment is the binder according to any one of embodiments 11 to 12, wherein the surface harness of the binder is no less than 75 times according to the test standard ISO 1522.

The 14^{th} embodiment is the binder according to any one of embodiments 11 to 13, wherein the solvent rub value of the binder is no less than 200 times according to MEK (methylethylketone) double rub test.

The 15^{th} embodiment is a 2K coating composition comprising the silane-functional hardener according to any one of embodiments 1 to 10 in one barrel and at least one carboxyl-functional resin in the other barrel.

The 16^{th} embodiment is the 2K coating composition according to the 15^{th} embodiment, wherein said carboxyl-functional resin comprise at least one selected from carboxyl-functional polyester, carboxyl-functional poly(meth)acrylate, carboxyl-functional polyurethane, carboxyl-functional polyurea, carboxyl-functional polyether, carboxyl-functional polyamide and/or their copolymers.

The 17^{th} embodiment is a coating layer obtained from the reaction of components in one barrel and components in the other barrel of the 2K coating composition according to any one of embodiments 15 to 16.

The 18^{th} embodiment is the coating layer according to the 17^{th} embodiment, wherein the surface harness of the coating layer is no less than 110 times according to the test standard ISO 1522.

The 19^{th} embodiment is the coating layer according to the 17^{th} embodiment, wherein the scratch resistance of the coating layer is no less than 70% according to 20° C. gloss retention test.

The 20^{th} embodiment is the coating layer according to any one of embodiments 17 to 19, wherein it is used as automotive coat comprising electrodeposition coat, primer, basecoat and clearcoat.

### EXAMPLES

The present invention will now be described with reference to Examples which are not intended to limit the present invention.

### Example 1: Preparation of Solvent-Borne Carboxylic Acid Functional Polyester

29.4 parts by weight of hexahydrophthalic anhydride (HHPA), 0.8 parts by weight of cyclohexane (CH), 10.6 parts by weight of dodecanoic acid (DDA) and 13.4 parts by weight of pentaerythritol (Penta) are charged to a stainless-steel reactor equipped with reflux condenser, water separator and N₂ inlet. The resulting reaction mixture is heated up to 185° C. under N₂. After an acid number of 150 mg KOH/g is reached, the reaction mixture is cooled to 120° C. and the polymer is diluted by the addition of a solution of 10.1 parts by weight of hexahydrophthalic anhydride (HHPA) in 32.1 parts by weight of solvent naphtha 160/180 (SN). The reaction mixture is hold at 120° C. until an acid number of 180 mg KOH/g is reached. Afterwards, the reaction mixture is diluted by 1-butanol (1-Bu) to reach the final solid content of 62%. The resulting polyester possesses a number-average molecular (M_{N}) weight of 1000 g/mol, a weight-average molecular weight (M_{w}) of 3000 g/mol, an OH value of 10 mg KOH/g and an acid value of 181 mg KOH/g solid.

### Example 2: Preparation of Solvent-Borne Carboxylic Acid Functional Polyacrylate

A stainless-steel reactor equipped with reflux condenser and N₂ inlet is charged with 13.2 parts by weight of 1-butanol (BU) and 16.6 parts by weight of solvent naphtha 160/180 (SN) and this initial charge is heated to 140° C. The reactor is placed under pressure (3.5 bar). Thereafter, over a period of 4.7 hours, an initiator solution (5.3 parts by weight of di-tertiary butylperoxide (DTBP) in 2.4 parts by weight of 1-butanol and 2.9 parts by weight of solvent naphtha) is metered in at a uniform rate with stirring. The monomer mixture containing 15.0 parts by weight of acrylic acid (AA), 26.0 parts by weight of n-butyl acrylate (nBA), 6.2 parts by weight of Styrene (St), 11.5 parts by weight of 2-ethyl hexyl acrylate (EHA) and 1.0 parts by weight of dodecyl mercaptan (DDM) is metered in at a uniform rate with stirring over a period of 4 hours. Afterwards, the reaction mixture is cooled to room temperature. The solid content of the resulting solution of polyacrylate is 65.8%. The resulting polyacrylate possesses a weight-average molecular weight (Mw) of 3000 g/mol and an acid value of 131 mg KOH/g solid.

### Example 3: Preparation of Water-Borne Carboxylic Acid Functional Polyacrylate

A stainless-steel reactor equipped with reflux condenser and N₂ inlet is charged with 12.5 parts by weight of butyl glycol (BG) and this initial charge is heated to 120° C. Thereafter, over a period of 4.5 hours, an initiator solution (1.2 parts by weight of tertiary butylperoxy-2-ethylhexanoate (TBPEH) in 1.2 parts by weight of butyl glycol) is metered in at a uniform rate with stirring. The monomer mixture containing 2.4 parts by weight of styrene (St), 4.9 parts by weight of 2-ethyl hexylmethacrylate (EHA), 7.0 parts by weight of methacrylic acid (MAA), 4.6 parts by weight of methyl methacrylate (MMA) and 5.4 parts by weight of n-butyl methacrylate (nBA) is metered in at a uniform rate with stirring over a period of 4 hours. Afterwards, the reaction mixture is cooled to 60° C. and diluted by the addition of a mixture of 5.7 parts by weight of 2-Dimethylaminoethanol (DMEA) and 55.1 parts by weight of water. The solid content of the resulting solution of polyacrylate is 27.6%. The resulting polyacrylate possesses a weight-average molecular weight (Mw) of 3800 g/mol, an acid value of 178 mg KOH/g solid and a neutralization degree of 75%.

### Example 4: Preparation of Water-Borne Carboxylic Acid Functional Polyester

3.9 parts by weight of adipic acid (ADA), 1.1 parts by weight of xylene (XY), and 7.4 parts by weight of trimethylolpropane (TMP) are charged to a stainless-steel reactor equipped with reflux condenser, water separator and N₂ inlet. The resulting reaction mixture is heated up to 230° C. under N₂. After acid value is constant, the reaction mixture is cooled to 90° C. and 5.2 parts by weight of hexahydrophthalic anhydride (HHPA) and 2.5 parts by weight of ethyl 3-ethoxypropionate (EEP) are added. The reaction mixture is hold at 115° C. Afterwards, 10.3 parts by weight of hexahydrophthalic anhydride (HHPA) are added and the reaction is hold at 115° C. until the acid number is constant. Afterwards, the reaction mixture is heated to 140° C. and 6.0 parts by weight of Cardura E10 are added. The reaction mixture is cooled to 60° C., is diluted by the addition of 9.5 parts by weight of methylethylketone (MEK) before a mixture of 5.7 parts by weight of 2-dimethylaminoethanol (DMEA) and 20.4 parts by weight of water is added. Afterwards, the methylethylketone (MEK) is stripped of to reach a final solid content of 50%. The resulting polyester possesses a a weight-average molecular weight (Mw) of 2500 g/mol, an acid value of 180 mg KOH/g solid and a neutralization degree of 72%.

### Example 5: Preparation of Epoxy-Functional Alkoxysilane Polymer

A reactor is charged with 16.6 parts by weight of solvent naphtha 160/180 (SN) and this initial charge is heated to 145° C. The reactor is placed under pressure (3.5 bar). Thereafter, over a period of 5 hours, an initiator solution (3.6 parts by weight of di-tert-butyl peroxide (DTBP) in 3.0 parts by weight solvent naphtha 160/180 (SN)) is metered in at a uniform rate with stirring. After 15 min of start of initiator feed, 25.6 parts by weight of vinyl trimethoxysilane (VTMS) is metered in at a uniform rate with stirring over a period of 1 hour. Simultaneously, a monomer mixture consisting of 4.9 parts by weight of methyl methacrylate (MMA), 12.2 parts by weight of n-butyl acrylate (nBA), 4.9 parts by weight of styrene (St), 24.5 parts by weight of glycidyl methacrylate (GMA) and 2.5 parts by weight of n-dodecane thiol (nDT) is simultaneously metered in at a uniform rate with stirring over a period of 4.5 hours. Following complete addition of the initiator solution, the reactor is heated to 155° C. and stirring is continued for 0.75 hours at the stated pressure, before a solution consisting of 1.2 parts by weight of di-tert-butyl peroxide (DTBP) in 1.0 parts by weight of solvent naphtha 160/180 (SN) is again added at a uniform rate over the course of 1.2 hours. Subsequently, the batch is held at the stated temperature and stated pressure for further 1.1 hours. The solid content of the resulting solution of polyacrylate is 74.8%. The copolymer possesses a number-average molecular (M_{N}) weight of 1350 g/mol and a weight-average molecular weight (Mw) of 4760 g/mol. The epoxy equivalent weight (EEW) of the copolymer is 539.

### Example 6: Preparation of Monomeric Silane Functional Beta-Hydroxy-Alkyl Urea Hardener

A 250 ml flask equipped with stirrer, temperature sensor, nitrogen inlet, condenser and dropping funnel is filled with 29.85 g diethanolamine (0.284 mol, 1 eq) and 70.3 g (0.284 mol, 1 eq) of 3-isocyanatopropyl-triethoxysilane are added dropwise by a dropping funnel over a period of 60 minutes. The temperature of the reaction mixture did not exceed 40° C. during addition. The reactor is maintained at 40° C. for additional 60 minutes. Afterwards, the product is poured into a container and sealed under a blanket of nitrogen. The solid content of the hardener is 100%.

### Example 7: Preparation of Oligomeric Silane Functional Beta-Hydroxy-Alkyl Urea Hardener I

A 250 ml flask equipped with stirrer, temperature sensor, nitrogen inlet, condenser and dropping funnel is filled with 53.88 g Desmodur® N 3600 (0.3 mol, 3 eq) and 42.57 g (0.1 mol, 1 eq) of Dynasylan 1122 are added dropwise by a dropping funnel over a period of 60 minutes. The temperature of the reaction mixture did not exceed 40° C. during addition. The reactor is maintained at 40° C. for additional 60 minutes. Afterwards, 21.03 g (0.2 mol, 2 eq) of diethanolamine are added dropwise by a dropping funnel over a period of 60 minutes. The temperature of the reaction mixture did not exceed 40° C. during addition. The reactor is maintained at 40° C. for additional 60 minutes. Finally, the product is poured into a container and sealed under a blanket of nitrogen. The solid content of the hardener is 97.1%.

### Example 8: Preparation of Oligomeric Silane Functional Beta-Hydroxy-Alkyl Urea Hardener II

A 250 ml flask equipped with stirrer, temperature sensor, nitrogen inlet, condenser and dropping funnel is filled with 53.88 g Desmodur® N 3600 (0.3 mol, 3 eq) and 85.14 g (0.2 mol, 2 eq) of Dynasylan 1122 are added dropwise by a dropping funnel over a period of 60 minutes. The temperature of the reaction mixture did not exceed 40° C. during addition. The reactor is maintained at 40° C. for additional 60 minutes. Afterwards, 10.51 g (0.1 mol, 1 eq) of diethanolamine are added dropwise by a dropping funnel over a period of 60 minutes. The temperature of the reaction mixture did not exceed 40° C. during addition. The reactor is maintained at 40° C. for additional 60 minutes. Finally, the product is poured into a container and sealed under a blanket of nitrogen. The solid content of the hardener is 100%.

### Example 9: Preparation of Water-Borne Oligomeric Silane Functional Beta-Hydroxy-Alkyl Urea Hardener I

A 250 ml flask equipped with stirrer, temperature sensor, nitrogen inlet, condenser and dropping funnel is filled with 53.88 g Desmodur® N 3600 (0.3 mol, 3 eq) and 72.37 g (0.17 mol, 1.7 eq) of Dynasylan 1122 are added dropwise by a dropping funnel over a period of 60 minutes. The temperature of the reaction mixture did not exceed 40° C. during addition. The reactor is maintained at 40° C. for additional 60 minutes. Afterwards, the reaction mixture is diluted by 10 g of methylethylketone and 22.61 g of Pluriol M750 (0.03 mol, 0.3 eq) are added and the reaction mixture is heated to 70° C. The reactor is maintained at 70° C. for additional 360 minutes. Afterwards, the reaction mixture is cooled to room temperature and 10.15 g (0.1 mol, 1 eq) of diethanolamine are added dropwise by a dropping funnel over a period of 60 minutes. The temperature of the reaction mixture did not exceed 40° C. during addition. The reactor is maintained at 40° C. for additional 60 minutes. Finally, the product is poured into a glass container and sealed under a blanket of nitrogen. The solid content of the hardener is 94.3%.

### Example 10: Preparation of Water-Borne Oliqomeric Silane Functional Beta-Hydroxy-Alkyl Urea Hardener II

A 250 ml flask equipped with stirrer, temperature sensor, nitrogen inlet, condenser and dropping funnel is filled with 53.88 g Desmodur® N 3600 (0.3 mol, 3 eq) and 42.57 g (0.1 mol, 1.0 eq) of Dynasylan 1122 are added dropwise by a dropping funnel over a period of 60 minutes. The temperature of the reaction mixture did not exceed 40° C. during addition. The reactor is maintained at 40° C. for additional 60 minutes. Afterwards, the reaction mixture is diluted by 10 g of methylethylketone and 22.61 g of Pluriol M750 (0.03 mol, 0.3 eq) are added and the reaction mixture is heated to 70° C. The reactor is maintained at 70° C. for additional 360 minutes. Afterwards, the reaction mixture is cooled to room temperature and 17.87 g (0.17 mol, 1.7 eq) of diethanolamine are added dropwise by a dropping funnel over a period of 60 minutes. The temperature of the reaction mixture did not exceed 40° C. during addition. The reactor is maintained at 40° C. for additional 60 minutes. Finally, the product is poured into a glass container and sealed under a blanket of nitrogen. The solid content of the hardener is 93.3%.

### Example 11 to 20: Preparation of Solvent-Borne and Water-Borne Binder

The components of Example 11 to 20 are given in Table 1-2 that are mixed and stirred until an even mixture is obtained. The mixtures are applied on tin test panels by doctor blading, to give a wet film thickness of 200 um, and are baked at 140° C. for 20 min to get tack free films. After 3 days of post curing single layer tests for performance check are conducted by evaluating the hardness (Koenig's pendulum) and crosslinking density (MEK double rub test). The dried and cured films of Examples 11-20 are obtained as Examples #11-#20. The performance tests of Examples #11-#15 are listed in Table 1 for solvent-borne (SB) mixtures. The performance test of Examples #16-#20 are list in Table 2 for water-borne (WB) mixtures.

### Example 21 to 26: Preparation and Application of 2K Clearcoat Composition

According to the amount in Table 3, resin having carboxylic acid groups, catalyst and solvent and optionally additives of leveling agent, defoamer and rheology modifier are mixed evenly to obtain Component I; monomeric silane functional beta-hydroxy-alkyl urea or oligomeric silane functional beta-hydroxy-alkyl urea and/or epoxy-functional alkoxysilane, alkylated melamine or melamine resin and optionally 3-Glycidoxypropyltrimethoxysilane monomer are mixed evenly to obtain Component II. Examples 21-26 are obtained 2K clearcoat compositions. The compositions are applied on black basecoat. The dried and cured films of Examples 21-26 are obtained as Examples #21-#26. From Table 3, it can be clearly seen that the invented technical approach can deliver high solid content, good appearance and better scratch, acid as well as alkali etch resistance if compared to conventional 2K polyurethane or acid/epoxy clearcoat.

### <Resin Characterization>

The skilled person is aware of methods for determining the acid value, OH value, epoxy equivalent weight, solid content as well as number-average and weight-average molecular weights. They are determined in accordance with the standards described hereinafter:

The acid value is determined in accordance with DIN EN ISO 2114 (date: June 2002). The OH value is determined in accordance with DIN 53240-2 (date: November 2007). The epoxy equivalent weight is determined in accordance with DIN EN ISO 3001 (date: November 1999). The solid content was determined in accordance with DIN EN ISO 3251 (date: June 2008). The number-average and weight-average molecular weights are determined in accordance with DIN 55672-1 (date: August 2007).

### <Solid Content>

Solid contents of the solvent-borne and water-borne binders as well as 2K clearcoat compositions listed in Table 1-3 is calculated based on the weight loss of the composition at 130° C. for 60 minutes.

### <Performance Tests>

### (1) Hardness

The pendulum damping test after Koenig or Persoz is used to mechanically measure the surface hardness of a coating. The hardness of the coating is determined by the number of oscillations made by the pendulum between two defined angles (6 to 3 degrees for Koenig pendulum or 12 to 4 degrees for Persoz pendulum). With increasing hardness of the coating surface, the number of oscillations is increasing. The methods are standardized in the specification ISO 1522.

### (2) Solvent Rub Test

To assess the crosslinking and to ensure the coating system has been cured, a solvent rub test is performed using methylethylketone (MEK) as the solvent. The test is used widely in the paint industry because it provides a quick relative estimation of degree of cure without having to wait for long-term exposure results. The rubs are counted as a double rub (one rub forward and one rub backward constitutes a double rub) which gives a measurable value for the MEK resistance and degree of cure. The MEK double rub values of conventional 2K polyurethane or acid/epoxy clearcoat is about 200 times.

### (3) Scratch Resistance

Scratch Resistance is evaluated by 20° gloss retention after dry scratch. Dry scratch was created by a crock meter equipped with PERSI abrasive paper (grain size: 10 micron). During the test, 15 back/forth repeats were performed. 20° gloss before and after dry scratch was compared. A higher gloss retention represents a better performance in scratch resistance. The 20° gloss retention of conventional polyurethane 2K clearcoat is about 40%.

### (4) Acid Etch Resistance

Acid Etch Resistance is evaluated by 20° gloss retention after acid treatment.

Acid treat met was created by immersing the coating into 0.35 M Fe(II)SO₄ solution in 0.5 M H₂SO₄. During the test the coating was completely covered by the acid and stored at 70° C. for 60 minutes. 20° gloss before and after acid treatment was compared. A higher gloss retention represents a better performance in acid etch resistance. The 20° gloss retention of conventional 2K polyurethane or acid/epoxy clearcoat is about 70%.

### (5) Alkali Etch Resistance

Alkali Etch Resistance is evaluated by 20° gloss retention after alkaline treatment. Alkaline treat met was created by immersing the coating into 1% sodium hydroxide solution. During the test the coating was completely covered by the alkaline solution and stored at 70° C. for 60 minutes. 20° gloss before and after alkaline treatment was compared. A higher gloss retention represents a better performance in alkali etch resistance. The 20° gloss retention of conventional 2K polyurethane or acid/epoxy clearcoat is about 60%.

TABLE 1
Solvent-borne binder

| Example | | 11 | 12 | 13 | 14 | 15 |
|---|---|---|---|---|---|---|
| Resin | SB Carboxylic Acid Functional Polyester [g] | 3.6 | 2.7 | 4.8 | 8.1 | — |
| | SB Carboxylic Acid Functional Polyacrylate [g] | — | — | — | — | 1.8 |
| Hardener | Monomeric Silane Functional Beta-Hydroxy-Alkyl Urea Hardener [g] | 6.3 | — | — | — | — |
| | Oligomeric Silane Functional Beta-Hydroxy-Alkyl Urea Hardener 1 [g] | — | 7.4 | — | — | 4 |
| | Oligomeric Silane Functional Beta-Hydroxy-Alkyl Urea Hardener 2 [g] | — | — | 6.1 | — | — |
| | Epoxy-Functional Alkoxysilane Polymer | — | — | — | 9.4 | — |
| Additive | BYK333 [g] | 0.1 | — | — | — | — |
| Solvent | Butyl acetate [g] | 7.2 | — | — | 6.5 | — |
| | 1-Butanol [g] | | 8.1 | 13.4 | — | 4.4 |

| | | | | | |
|---|---|---|---|---|---|
| Solid Content [%] | 50.0 | 50.1 | 36.8 | 50.0 | 50.8 |

| Example | | #11 | #12 | #13 | #14 | #15 |
|---|---|---|---|---|---|---|
| Performance | Koenigs Pendulum [times] | 123 | 165 | 147 | 114 | 146 |
| | MEK Double Rub [times] | 500+ | 500+ | 500+ | 450 | 500+ |

TABLE 2
Water-borne binder

| Example | | 16 | 17 | 18 | 19 | 20 |
|---|---|---|---|---|---|---|
| Resin | WB Carboxylic Acid Functional Polyacrylate [g] | 7.4 | 2.9 | 4.8 | 2.8 | — |
| | WB Carboxylic Acid Functional Polyester [g] | — | — | — | | 1.6 |
| Hardener | Monomeric Silane Functional Beta-Hydroxy-Alkyl Urea Hardener [g] | 2 | — | — | — | — |
| | WB Oligomeric Silane Functional Beta-Hydroxy-Alkyl Urea Hardener 1 [g] | | 4.5 | — | 4.4 | 5.6 |
| | WB Oligomeric Silane Functional Beta-Hydroxy-Alkyl Urea Hardener 2 [g] | — | — | 3.9 | | — |
| Additive | Hydrosil 2926 [g] | | — | | 2.9 | 2.9 |
| | BYK307 [g] | 0.2 | — | — | — | — |
| Solvent | Water [g] | — | 2.7 | 1.4 | — | — |

| | | | | | |
|---|---|---|---|---|---|
| Solid Content [%] | 50.0 | 50.9 | 50.4 | 59.7 | 72.2 |

| Example | | #16 | #17 | #18 | #19 | #20 |
|---|---|---|---|---|---|---|
| Performance | Koenigs Pendulum [times] | 95 | 76 | 75 | 76 | 75 |
| | MEK Double Rub [times] | 500+ | 450 | 500+ | 500+ | 500+ |

TABLE 3
2K clearcoat composition

| Example | | | 21 | 22 | 23 | 24 | 25 | 26 |
|---|---|---|---|---|---|---|---|---|
| Component A | Resin | SB Carboxylic Acid Functional Polyester [g] | 8.1 | 8.1 | 8.1 | 8.1 | 8.1 | 8.1 |
| | Solvent | Butyl acetate [g] | 4.7 | 2.7 | 2.7 | 2.7 | — | — |
| | | 1-Butanol [g] | — | — | — | — | 1.7 | 1.7 |
| | Catalyst | Phenyl acid phosphate [g] | 0.13 | 0.14 | 0.17 | 0.17 | 0.17 | 0.2 |
| | | NARCUR 4575 [g] | 0.12 | 0.13 | 0.15 | 0.15 | 0.15 | 0.18 |
| | Additive | BYK3190 [g] | 0.06 | 0.06 | 0.08 | 0.08 | 0.08 | 0.16 |
| Component B | Hardener | 3-Glycidoxypropyltrimethoxysilane [g] | 4.1 | — | 2.9 | — | — | — |
| | | Monomeric Silane Functional Beta-Hydroxy- | — | — | — | 0.5 | — | — |
| | | Alkyl Urea Hardener [g] | | | | | | |
| | | Oligomeric Silane Functional Beta-Hydroxy- | — | — | — | — | 0.6 | — |
| | | Alkyl Urea Hardener 1 [g] | | | | | | |
| | | Oligomeric Silane Functional Beta-Hydroxy- | — | — | — | — | — | 0.75 |
| | | Alkyl Urea Hardener 2 [g] | | | | | | |
| | | Epoxy-Functional Alkoxysilane Polymer [g] | — | 9.9 | 7 | 9.4 | 9.4 | 12.1 |
| | Co-hardener | Luwipal 016 [g] | 3.14 | 3.14 | 3.14 | 3.14 | 3.14 | 3.79 |
| | Solvent | Butyl acetate [g] | — | 2 | — | 4 | — | — |
| | | 1-Butanol [g] | — | — | — | — | 5 | 2.4 |

| | | | | | | |
|---|---|---|---|---|---|---|
| Solid Content [%] | 58.2 | 56.3 | 57.1 | 52.8 | 50.9 | 50.1 |

| Example | | #21 | #22 | #23 | #24 | #25 | #26 |
|---|---|---|---|---|---|---|---|
| Performance | Koenigs Pendulum [times] | 113 | 116 | 114 | 126 | 122 | 110 |
| | MEK Double Rub [times] | 500+ | 500+ | 500+ | 500+ | 500+ | 500+ |
| | Scratch Resistance [% gloss retention @20°] | 65.9 | 76.5 | 73.0 | 72.5 | 73.1 | 70.1 |
| | Acid Resistance [% gloss retention @20°] | 99.1 | 88.1 | 99.2 | 99.7 | 98.1 | 90.1 |
| | Alkali Resistance [% gloss retention @20°] | 97.3 | 92.1 | 99.8 | 99.9 | 98.7 | 92.1 |

1. A silane-functional hardener for carboxyl-functional resins comprising at least one monomer and/or oligomer and/or polymer having at least one group represented by Formula I-(a) and/or Formula I-(b) and at least one group represented by Formula II-(a) and/or Formula II-(b): 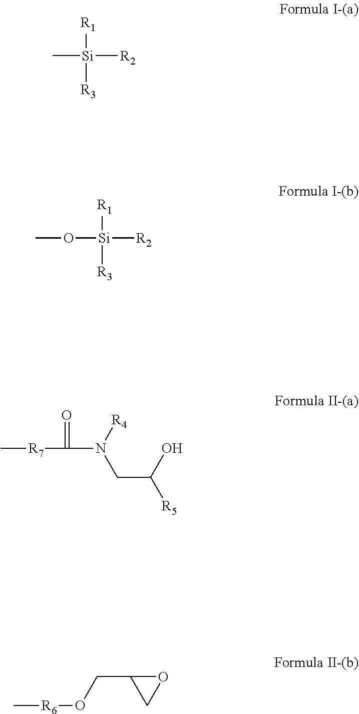
wherein, R₁, R₂ and R₃ independently represent a C1-C18 alkyl group, a C1-C6 alkoxyl group, a phenyl group, an aryl group, a hydrogen atom, a chlorine atom or a fluorine atom and at least one of R₁, R₂ and R₃ is C1-C6 alkoxyl group, R₄ represents a C1-C18 alkyl group, C1-C6 alkanol group, C1-C6 alkoxyl group, or a hydrogen atom, R₅ represents a hydrogen atom, C1-C18 alkyl group, or C1-C6 alkoxyl group, R₆ represents a C2-C6 acyl group, C1-C18 alkylene group or arylene group and R₇ represents a —NR₄— group, C2-C6 acyl group, C1-C18 alkylene group, C1-C18 alkoxy group or arylene group.

2. The silane-functional hardener for carboxyl-functional resins according to claim 1, wherein R₁, R₂ and R₃ in Formula I-(a) and Formula I-(b) represent a C1-C6 alkoxyl group.

3. The silane-functional hardener for carboxyl-functional resins according to claim 1, wherein R₄ in Formula II-(a) represents a C1-C6 alkanol group and R₅ in Formula II-(a) represents a hydrogen atom.

4. The silane-functional hardener for carboxyl-functional resins according to claim 1, wherein R₆ in Formula II-(b) represents carbonyl or a C2-C6 acyl group.

5. The silane-functional hardener for carboxyl-functional resins according to claim 1, wherein the molar ratio of groups represented by Formula I-(a) and Formula I-(b) and groups represented by Formula II-(a) and Formula II-(b) is from 0.1 to 10.

6. The silane-functional hardener for carboxyl-functional resins according to claim 1, wherein a backbone of said oligomer comprises at least one component selected from the group consisting of (meth)acrylate oligomer and/or its co-oligomer, isocyanate oligomer and/or its co-oligomer.

7. The silane-functional hardener for carboxyl-functional resins according to claim 1, wherein a backbone of said polymer comprises at least one component selected from the group consisting of poly(meth)acrylate and/or its copolymer, polyurea and/or its copolymer.

8. The silane-functional hardener for carboxyl-functional resins according to claim 7, wherein said copolymer comprises at least one alkoxysilane and epoxy and/or amine functionalized carbonyl compound as end groups or side groups.

9. The silane-functional hardener for carboxyl-functional resins according to claim 8, wherein said amine functionalized carbonyl compound is at least one selected from the group consisting of amide, urethane and urea.

10. The silane-functional hardener for carboxyl-functional resins according to claim 1, wherein said hardener is solvent-borne or water-borne.

11. A binder obtained from a reaction of the silane-functional hardener according to claim 1 and at least one carboxyl-functional resin.

12. The binder according to claim 10, wherein said carboxyl-functional resin comprises at least one component selected from the group consisting of carboxyl-functional polyester, carboxyl-functional poly(meth)acrylate, carboxyl-functional polyurethane, carboxyl-functional polyurea, carboxyl-functional polyether, carboxyl-functional polyamide and their copolymers.

13. The binder according to claim 11, wherein the surface harness of the binder is no less than 75 times according to the test standard ISO 1522.

14. The binder according to claim 11, wherein the solvent rub value of the binder is no less than 200 times according to MEK (methylethylketone) double rub test.

15. A 2K coating composition comprising the silane-functional hardener according to claim 1 in one barrel and at least one carboxyl-functional resin in the other barrel.

16. The 2K coating composition according to claim 15, wherein said carboxyl-functional resin comprises at least one component selected from the group consisting of carboxyl-functional polyester, carboxyl-functional poly(meth)acrylate, carboxyl-functional polyurethane, carboxyl-functional polyurea, carboxyl-functional polyether, carboxyl-functional polyamide and their copolymers.

17. A coating layer obtained from the reaction of components in one barrel and components in the other barrel of the 2K coating composition according to claim 15.

18. The coating layer according to claim 17, wherein the surface harness of the coating layer is no less than 110 times according to the test standard ISO 1522.

19. The coating layer according to claim 17, wherein the scratch resistance of the coating layer is no less than 70% according to 20° C. gloss retention test.

20. The coating layer according to claim 17, wherein the coating layer is used as an automotive coat comprising electrodeposition coat, primer, basecoat and clearcoat.
